(19) United States
(12) Patent Application Publication
(10) Pub. No.: US 2002/0186131 A1
(43) Pub. Date: Dec. 12, 2002

(54) Card security device

(76) Inventor: Brad Fettis, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/137,305

(22) Filed: May 3, 2002

Related U.S. Application Data
(63) Continuation-in-part of application No. 09/824,043, filed on Apr. 3, 2001.

(51) Int. Cl. G08B 13/14

(52) U.S. Cl. 340/568.1; 340/568.7; 340/693.5

(57) ABSTRACT

A card security device for cards which have coded information on or within the cards has a mechanically closeable and releasably lockable card vault for releasable locking enclosure of cards within the card vault, the card vault releasably lockable by a releasable lock. The lock is releasable by a recognition processor upon recognition of a user's biometric sample by the recognition processor. An incorrect recognition sample by a user, or forcible entry into the card vault either by forced releasing of the vault door or disruption of the vault casing results in a triggering of a destruction device for rendering useless and unrecoverable by disfigurement or destruction by the destruction device of the coded information on the information carrying medium.

### CROSS REFERENCE TO RELATED APPLICATION

This application is a Continuation-in-Part from U.S. patent application Ser. No. 09/824,043 filed Apr. 3, 2001.

### FIELD OF INVENTION

This invention relates to the field of portable vaults or portable lockable security containers, and in particular to portable security containers for cards such as credit cards.

### BACKGROUND OF THE INVENTION

Credit card sized cards, which includes cards which may have dimensions typically in the order of 3⅜ inch×2⅛ inch planar rectangular dimensions, and where typically the card may be 1/32 inch thick, are in common use by a large percentage of the population. Commonly, such cards are somewhat flexible and made of plastic so as to be conveniently carried. Such cards are prevalently used to carry information about the user, sometimes on a magnetic stripe along the length of the card, such information including type and quantity of financial credit available to user, coding information to access a user's bank account so as to debit that account, and coded information identifying the bearer of the card as being entitled to access through a controlled access entry.

Such cards, if stolen, can be used by unscrupulous third parties to the detriment of the owner of the card. Consequently, it is desirable that such cards be contained in a conveniently portable vault where, advantageously, the vault will deter unauthorized access to the cards held within the vault, will render the cards unusable if the vault is forced open, and, further advantageously, where the vault will remind the user to replace the cards into the vault after a timely delay so as to prevent inadvertent loss of the cards, for example, following use in a restaurant.

It is recognized in the prior art that it is desirable to in some manner prevent the unauthorized use of a credit card or to prevent the unauthorized removal of such objects from a receptacle for carrying such objects by means of password security such as an exterior keypad requiring a specific number sequence for disarming an alarm. In particular, Applicant is aware of U.S. Pat. No. 5,365,046 which issued to Haymann on Nov. 15, 1994 for a method of preventing unauthorized use of a credit card. Haymann teaches the use of a personal identification number by a credit card holder, the user entering the personal identification number at the time of a credit card transaction so that the number may be compared with a personal identification number corresponding to that credit card stored in a database at a remote site.

Applicant is also aware of U.S. Pat. No. 4,755,802 which issued to Urbanczyk on Jul. 5, 1988 for a handbag, briefcase and luggage alarm. Urbanczyk discloses the use of an alarm on a receptacle such as a handbag, briefcase or luggage which, when armed, is triggered when the receptacle is opened. The receptacle alarm may be disarmed by use of an exterior keypad programmed to receive a specific number sequence.

Applicant's previous Patent Cooperation Treaty Application No. WO 98/38407, published Sep. 3, 1998, taught the use of a lockable vault requiring a code for access. A keypad was built into one wall of the vault for data entry, such as for entry of an access code. The inclusion of a keypad meant however that he vault was weakened in the area, providing third parties with a point of entry where the security of the vault might be breached. Similarly, the patent application of Kitt, European Patent Application No. 88302508.2 filed Mar. 22, 1988 and published Sep. 28, 1988, teaches a security device for credit cards and the like wherein credit cards may be inserted into a closable container which is locked shut and where entry is controlled by entering a numeric code onto a key pad. Repeated attempts to enter an incorrect code or submersion of the device in water, or attempts at force entry for example by drilling or sawing results in ignition of a pyrotechnic within the container to thereby destroy any cards in the container.

In the prior art, Applicant is also aware of numerous devices which provide receptacles for carrying objects such as credit cards in which the receptacle has an alarm which is triggered by the absence of the object. In particular, Applicant is aware of the following United States patents:

U.S. Pat. No. 4,480,250 which issued Oct. 30, 1984 to McNeely for a credit card carrier with alarm,

U.S. Pat. No. 4,652,865 which issued Mar. 24, 1987 to Maharshak for a card holder,

U.S. Pat. No. 4,692,745 which issued Sep. 8, 1987 to Simanowitz for a credit card alarm,

U.S. Pat. No. 4,717,908 which issued Jan. 5, 1988 to Phillips et al for a credit card case with alarm system,

U.S. Pat. No. 4,719,453 which issued Jan. 12, 1988 to Beck et al for a card carrier having an alarm,

U.S. Pat. No. 4,721,948 which issued Jan. 26, 1988 to Lin for a wallet with missing-card reminder,

U.S. Pat. No. 4,870,405 which issued Sep. 26, 1989 to Fletcher for an object monitoring and alarm device,

U.S. Pat. No. 4,890,094 which issued Dec. 26, 1989 to Kopel for a wallet incorporating credit card alarm system,

U.S. Pat. No. 4,916,434 which issued Apr. 10, 1990 to McNeely for a credit card carrier with alarm,

U.S. Pat. No. 5,053,749 which issued Oct. 1, 1991 to Weiss for a retainer for documents with alarm.

The Maharshak and Weiss patents also disclose use of a timer cooperating with the alarm so that the triggering of the alarm may be delayed by a timed interval to allow for a credit card transaction to take place and the card to be reinserted into the receptacle thereby preventing unnecessary triggering of the alarm.

Thus it is an object of the present invention to provide a compact, portable, rupture resistant card security device to provide physical protection of cards held within such a device so as to prevent unauthorized access to, and use of, the protected cards.

It is a further object of the present invention to provide a card security device where in addition to physical protection of the card in the manner of a hardened vault, the card security device provides active defence mechanisms including destruction of the utility of the card upon forced entry into the vault. Further, it is an object of the invention to provide the user of the card security device with an alert such as audible alert to warn the user that the cards kept within the vault are temporarily out of the vault and, presumably, in use, and that those cards have not been returned to the vault in a timely fashion.

It is a further object of the invention to provide a hardened card vault which does not have weakened entry points on the case such as provided by a keypad, but rather which allows a user access to cards stored within the vault upon successful recognition of a biometric such as behaviour pattern repetition by the user and recognition of that behaviour pattern by a recognition processor. Failure to repeat the correct behaviour pattern, upon repeated attempts, renders entry to the vault impossible either indefinitely or for a timed period, or which, upon repeated efforts at entry into the vault, activates one or more of the active defence mechanisms of the card protection device.

As observed by Stapleton in the May, 2001 PKI Forum Note on Biometrics, the ability to validate that an individual is actually the person with whom a system is communicating or conducting a transaction is called authentication. Authentication is accomplished using one or more of three validation approaches: knowledge factor (something the individual knows), possession factor (something the individual has), or a biometric factor (something physiologically unique about the individual). Knowledge factors are something an individual “knows” such as a personal identification number or password, such as the numeric code required by use of the Kitts device. Possession factors are something an individual “has” such as a door key. A biometric factor is something physiologically unique about an individual such as for example, a fingerprint, facial image, iris scan, voice pattern, or handwriting. When an individual wants system access, a sample is taken of the authenticatee's biometric data, for example, a digitized signature or, as taught herein, that persons repetitive behaviour or that persons fingerprint. Then, the authenticator, using a previously enrolled version of the same biometric (called a template), can match the sample against the stored template to verify the individual's identity. Biometrics may not be secret, as in the case of fingerprints everyone leaves them everywhere they go. In that case the security of the system therefore relies on the integrity and authenticity of the biometric information. In the case of behaviour pattern recognition, so long as the repetitive behaviour is not observed or recorded by a third party, the biometric factor may remain secret enhancing the security above that obtainable by the use of biometric factors which leave a trace or may be easily recorded or observed by a third party.

The data representation of a biometric characteristic or measurement derived from an individual's fingerprint, voice, iris, face, or behaviour including handwriting, which is captured or scanned by a biometric device, is called a biometric sample. The information extracted from one or more biometric samples is used to create a biometric template. An individual is authenticated when a current biometric sample is found equivalent to, or “matches”, the biometric template. Both the biometric sample and the biometric template are called biometric data, or biometric information. An automated system capable of collecting, distributing, storing and processing biometric data, and returning a decision (match or non-match), is called a biometric system. The present invention is an example of one such system.

A typical authentication process utilizing biometric technology consists of the following basic steps:

1. Capture the biometric data using a physical reader device;

2. Evaluate the quality of the captured biometric data and recapture if necessary;

3. Process the captured biometric data to create a biometric sample;

4. Match the biometric sample with a previously enrolled template, or templates, to determine if a match exists. This matching can be done as verification or identification.

### SUMMARY OF THE INVENTION

The invention may be described generally as a mechanically closable and releasably lockable card vault for releasable locking enclosure of cards within the card vault where the cards have information coded on the cards or within the cards and where the information is confidential coded information which is the subject of protection by the present invention. The cards may be credit cards, debit cards, smart cards, security access cards or any other security information carrying card or the like which carry confidential information on or within the card by information carrying means such as magnetic stripes, logic semi-conductor chips or the like.

The card vault is completely sealed when its door is closed. No keypads or other areas of weakened security are exposed to the outside. The door has a releasable locking means releasable by a biometric recognition processor. The recognition processor cooperates with a sensor so as to enrol biometric data to form a template during a training phase, and so as to capture biometric data such as repetitive behaviour to form a biometric sample during use of the device, the processor matching the sample with the template to identify a recognised biometric such as the pattern of behaviour of the user and thereafter unlock the vault door allowing access or otherwise provide for access into the vault. Thus the vault door on the card vault may in one embodiment of the present invention only be opened upon recognition of the pattern of behaviour by the recognition processor. A repeated incorrect behaviour pattern by the user or forcible entry into the card vault either by forced releasing of the vault door or disruption of the vault case results in a triggering of a destruction means whereby the confidential information on the information carrying means is rendered useless and unrecoverable by being disfigured or destroyed by the destruction means. The destruction means may include electrical burning or fusing by a heated wire or flash means, resistor or like element, or permanent disfigurement by ink or corrosive fluid or by permanent liquid adhesive or the like.

In an alternative embodiment, mechanical destruction means may be employed to mechanically disfigure or destroy the information carrying means on a card if, once the vault door has been forced open, a card held within the card vault is forcibly removed from the vault. Such mechanical destruction means may include toothed card engagement means releasably engagable onto a card held in the vault by a traction or friction device having means for cutting, embedding or ripping into the card in the manner of a ratchet gear or a barbed device if the card is forcibly removed from the card vault without the toothed engagement means being released from the traction or friction engagement against the card prior to the card being removed. One such means may be a toothed traction wheel selectively biased against a magnetic stripe on a card held within the card vault whereby the teeth on a toothed traction wheel permanently disfigure the magnetic stripe coating thereby rendering the confidential information irretrievably unusable and unrecoverable. Alternatively, the mechanical destruction means may be a “scrape gate” such as a sharp blade selectively releasably biased as by spring-loaded pressure against the information carrying means.

In the preferred embodiment, the card vault case is adapted to form a Faraday Shield by means of grounding of the enveloping metal vault case, thereby providing the card vault with a defence against electronic assault.

In the present invention no keypad is provided so that it is impossible to gain forced access to the card vault door via the keypad. Further, the hinge and closing mechanism for the card vault door forms a continuous closed seal around the perimeter of the door to inhibit access between the door and the card vault case with a prying tool.

Predeterminable adjustable variables within pre-programmed software routines in an EEPROM allow adjustable tailoring of the active defence of the confidential information on the cards within the card vault, for example, adjusting the time period during which the code entry and recognition processor would cause the card vault to go inactive, “sleep” or “lock-down” upon unrecognized attempted entry.

In alternative embodiments, the destruction means which operates by means of electrical burning or fusing of the information carrying means on the card may include a fuser assembly which may take many different forms as, for example, electrochemical, electrical or merely a bum-in template for burning in words such as “void” onto the information carrying means on the card. The fuser assembly may be in the form of camera flash bulbs or flash filaments, and may be adapted for fusing predetermined spots on the information carrying means depending on the type of the information carrying means employed by the card intended to be inserted into the card vault. Using the example of the magnetic stripe information carrying means, then selective spots may be fused on the magnetic stripe to selectively disfigure selected information on the magnetic stripe.

The destruction means may also include means to electrically damage the information carrying means on logically controlled “smart” cards carried within the card vault or may include magnetic destruction means to destroy, disfigure or otherwise render useless and unreadable a magnetic stripe bearing code information.

In a further alternative embodiment, the card security device of the present invention provides a card case for holding a credit card sized card, where the case has built-in ink, or like permanent marking solution reservoirs and built-in electrical magnetic strip demagnetizing means so that unauthorized removal of a card from the card case will cause the card to be permanently marked by the fluid in the reservoirs and will also cause the magnetic strip on the rear surface of the card to be permanently damaged. Access, that is, removal of the card from the case, is governed by the recognition processor recognizing the user, for example, by the user's behaviour patterns. Recognition disarms the circuitry controlling the permanent marking means and magnetic strip demagnetizing means in the card case so as to allow the removal of the card from the case without damaging the card.

In the event that the card case of the present invention is forcibly broken open, the permanent marking fluid reservoirs rupture to permanently mark the card. In the event that the card is removed from the card case without recognition of the user by the recognition processor, the permanent marking fluid in the reservoirs is released onto the card and the magnetic strip demagnetizing means is activated so as to damage or erase the magnetic strip on the card rendering the card both sufficiently marked so as to alert a teller or clerk manipulating the card during a card transaction, and electrically damaged so that a teller or clerk would be forced to look at the card to ascertain the account number for manual entry into the computerized system maintained by the card issuing institution.

The card case is also provided with an alarm which is timed so that after a preset time from authorized removal of the card from the card case, if the card has not been returned to the card case, the alarm is triggered.

In summary then, the card security device of the present invention for cards which have coded information stored on information storage media on or within the cards includes a releasably and lockably closable card vault, wherein the vault does not have an external keypad, the vault having a door for releasable locking enclosure of at least one of said cards within said card vault wherein within the vault, a locking actuator for locking and unlocking the door on the vault cooperates with a recognition processor, the recognition processor cooperating with a biometric sensor. Thus, the card vault has a casing which, when closed, has no substantially structurally weakened areas which may provide for a breach access during assault on said casing.

In one embodiment the card vault is releasably and lockably closable by a latch. The biometric sensor may provide data for behaviour pattern recognition. The locking actuator may cooperate with the latch for locking closed the door on the card vault. The actuator may be a latch actuator to release the latch so as to allow the door to be opened upon recognition of a correct behaviour pattern by the behaviour pattern recognition processor. Repeated incorrect behaviour patterns by a user, or assault of the card vault results in a triggering, by a monitoring and triggering means mounted within the vault, of a destruction means for rendering useless and unrecoverable the coded information on the information storage media.

The processor and the destruction means may be mounted within the vault on a support adjacent the cards. The cards may include a pair of cards, and the card vault may include a card cradle for slidable mounting of the pair of cards in parallel array therein so as to sandwich the support therebetween. Further, the support may be a planar core support on which is mountable a battery.

The card security device may also include key means cooperating with the latch actuator so as to prevent releasing of the latch without proximity of, and cooperation between, the key means with a key input receiver in the vault, wherein the key input receiver does not intrude into the cavity of the vault.

The vault door may seat into a recess in the casing so as to be flush with the casing when the door is closed. A continuous hinge and continuous seal for the card vault door may be provided so as to form a continuous closed seal around a perimeter of the card vault door to inhibit access with a prying tool between the card vault door and the casing.

The card cradle may include alignment and orientation means for biasing the position of the pair of cards within the casing so as to bring the information storage media into proximity with the destruction means. The alignment and orientation means may be parallel slots between the support and interior walls of the casing. The slots may have raised lands to prevent raised text on the pair of cards from being inserted into the narrow portions of the slots which have been narrowed by the raised lands.

Where the information storage media are magnetic stripes oppositely disposed on the cards from the card's raised text, the raised lands are on the interior walls of the casing so as to bias the magnetic stripes towards the support when the pair of cards are inserted in the slots.

### BRIEF DESCRIPTION OF THE DRAWINGS

FIG. 1 is, in perspective view, the card security device of the present invention.

FIG. 2 is, in plan view, the card security device of FIG. 1.

FIG. 3 is a cross-sectional view along line 3-3 in FIG. 1.

FIG. 3a is an enlarged partially cut-away portion of FIG. 3.

FIG. 4 is a cross-sectional view along line 4-4 in FIG. 1.

FIG. 5 is, in enlarged partially cut-away perspective view, the latching mechanism of the card security device of FIG. 1.

FIG. 5a is a cross-sectional view along line 5a-5a in FIG. 5.

FIG. 6 is a cross-sectional view through the vault door and hinge of the card security device of FIG. 1.

FIG. 7 is, in perspective view, an information-carrying card for insertion into the card security device of the present invention.

FIG. 8 is, in perspective view, a further alternative embodiment of the card security device of the present invention.

FIG. 9 is, in perspective view, a first clamshell-half of the vault of the card security device of FIG. 8.

FIG. 10 is a second clamshell-half of the vault of FIG. 8.

FIG. 11 is, in perspective view, the drawer of the card security device of FIG. 8.

FIG. 12 is, in perspective partially cut away view, a further alternative embodiment of the card security device of FIG. 8 with its drawer in its open position.

FIG. 13 is, in perspective view, the battery housing of the card security device of FIG. 8.

FIG. 14 is, in perspective view, the battery compartment door of the battery compartment of FIG. 13.

FIG. 15 is, in perspective view, the alternative embodiment of FIG. 12 with the drawer in its closed position.

### DETAILED DESCRIPTION OF EMBODIMENTS OF THE INVENTION

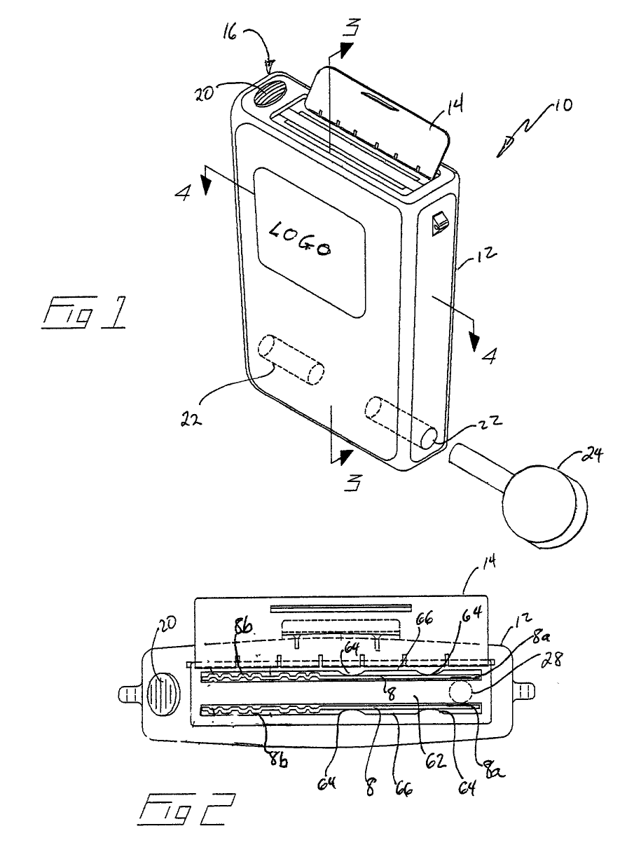

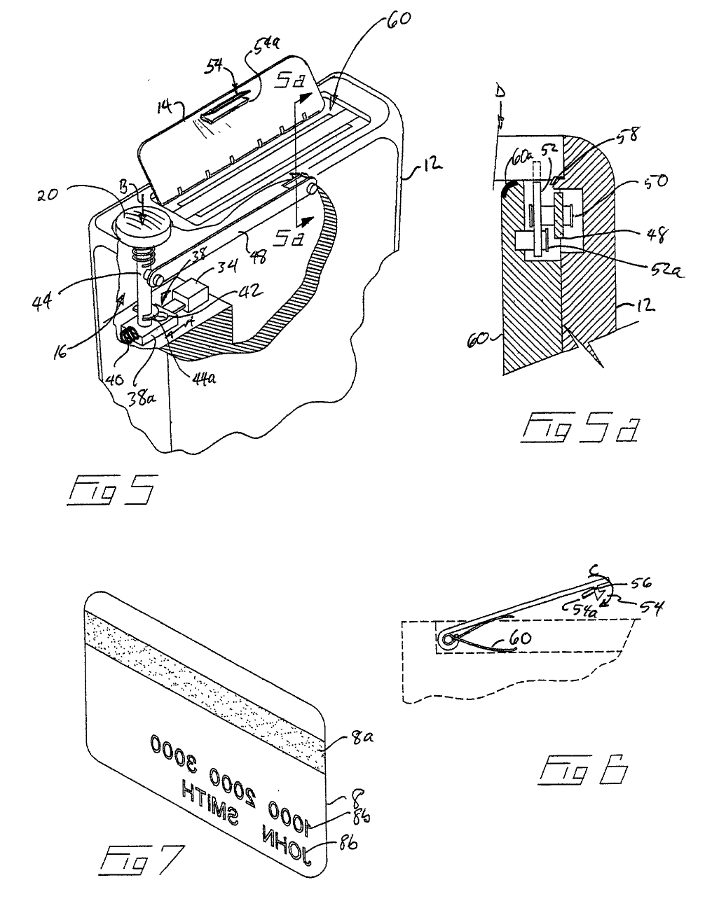

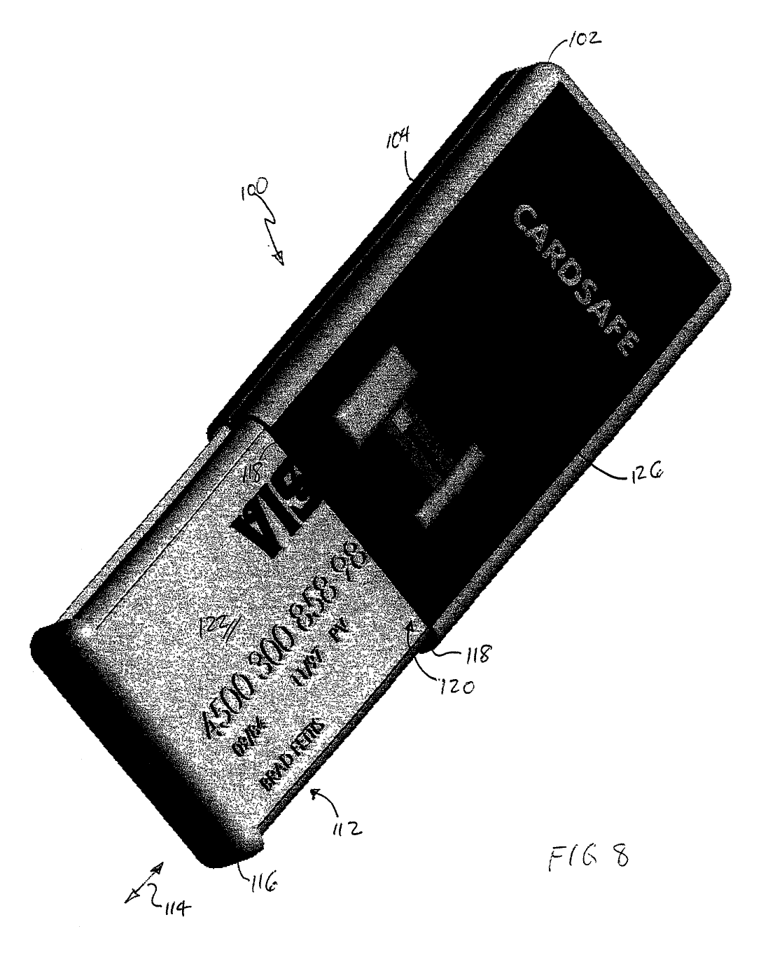

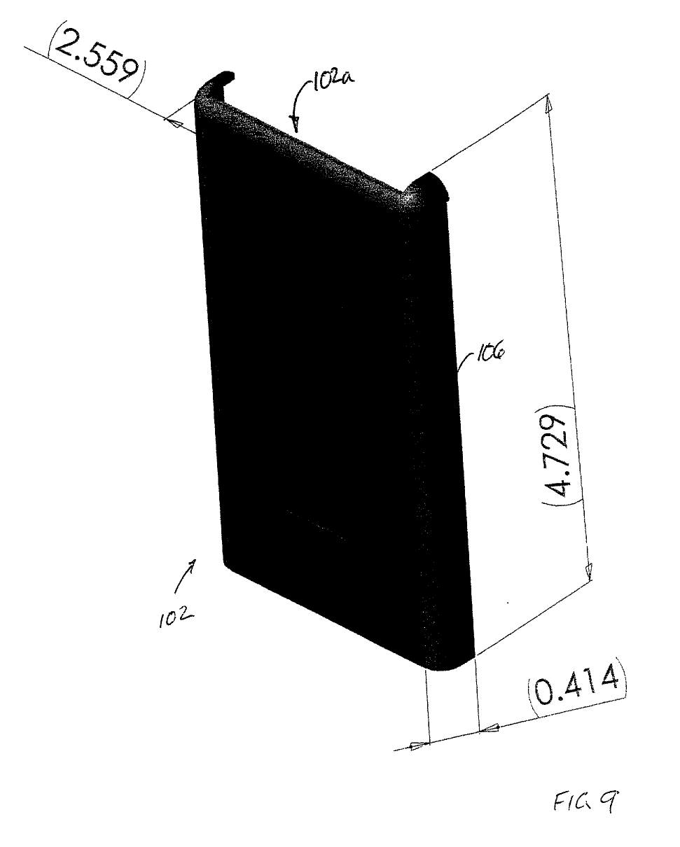

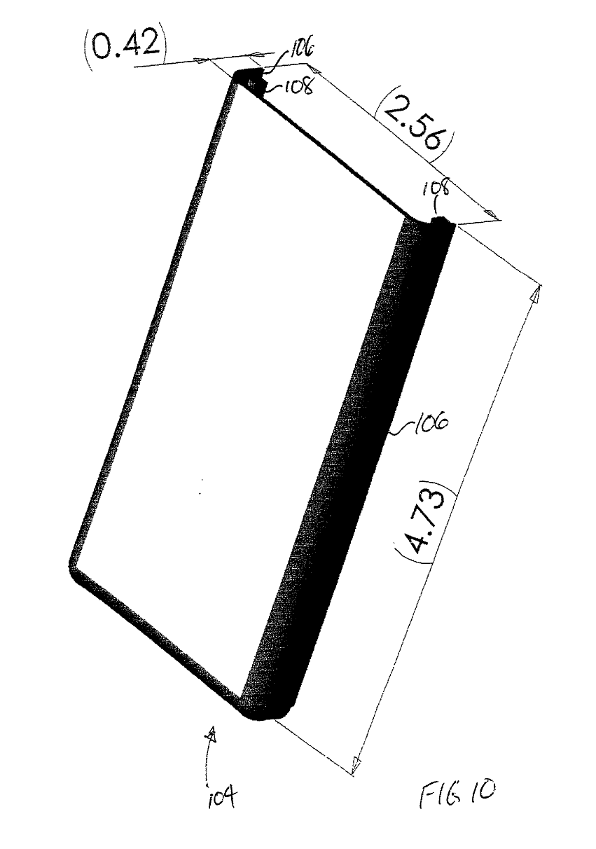

As seen in FIGS. 1 and 2, the card security device 10 of the present invention includes a protective vault 12 to control access to security, identity, key or credit cards, for example, based on magnetic stripe data storage technology (collectively cards 8 such as seen in FIG. 7). The vault may be essentially seamless and preferably watertight, with an access door 14 at one end. A release mechanism 16, in one embodiment a mechanical release, allows removal of cards 8 from the vault. The vault may have no obvious or visually apparent method of access. The vault can store and actively protect two cards 8 inside.

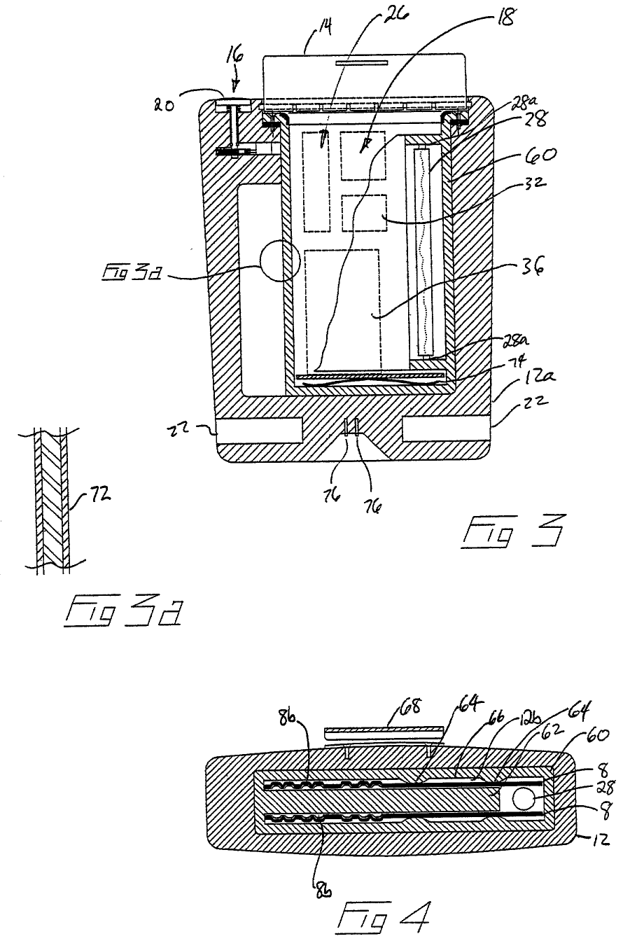

Using a biometric such as behavior pattern recognition as hereinafter described, processor 18 (shown in dotted outline in FIG. 3) in the vault can be trained to enroll or remember a user's unique and personal sequence of movements and key operations to control access to cards 8 inside. Once the pattern has been recognized by processor 18, a door release button 20 will function, allowing the user to safely remove the cards inside. Incorrect attempts to open the vault are tracked by the processor and cause the processor to reject further attempts, and if continued, to destroy the cards inside. Defenses may be both passive and active, and provide deterrents to both operational and physical assaults on the vault.

In one embodiment, processor 18 is trained by insertion of a training mode card (not shown), which activates a training mode, and guides the new user through exercises to train the processor. Once the processor is trained, i.e. programmed, the training mode card is removed, and the vault is now ready to operate and protect the user's cards. Because the vault is accessed via behavior recognition, not a numerical sequence, or PIN number, it is far harder to reveal the data or for an unauthorized third party to gain access to the vault.

The bottom of the case may have at least one bore hole 22 that can be used with secondary keys 24 (either mechanical, optical, RFID Tag based, or memory based) to allow special modes of operation, such as two user (supervisor permission) or higher security modes of operation.

The vault of the present invention avoids many problems associated with numerical access techniques by using biometric sensing and recognition, for example that of pattern behavior to open the vault. Numbers, codes, and PIN techniques are easily compromised and often very simplistic in nature, allowing the information to easily become known, and the vault opened. On the other hand, pattern behavior recognition is a biometric, that is, physiologically unique to the owner in that it is based on natural physical motion sequences used almost subconsciously by the owner, and thus is very difficult to learn or copy by others. The processor in the vault essentially learns a habit or motion comfortable and unique to the owner, and then responds only to that sequence to permit access. In addition, removal of prior art keyboards or other numerical input devices allows a much more robust and more difficult to compromise case design that can be made watertight.

The vault is opened by recognition of the pattern behavior associated with the correct owner. This can take the form of physical motions over a specific time. In its simplest form, a simple mechanical key can be inserted into one side of a bottom access hole such as bore hole 22 (which does not open into the sealed vault area) for a specific time, and this combined with the physical orientation of the unit, to give access. This permits supervisor permission, or much higher security to be implemented. Biometric sensors 26 such as accelerometers or other motion detectors are employed to detect motion and to send corresponding signals to processor 18.

Defenses against intrusion are layered. They first take the form of disregarding further entry attempts, once it is established that the sequence is clearly wrong, then escalate to active destruction of the cards inside if an attempt is made to breach the vault or invalid attempts persist to try and gain access to the cards. For example, active destruction may be achieved by use of an exothermic flash lamp system that flashes a flash bulb 28 to vaporize the magnetic stripe 8a on each card 8. Bulb 28 may also be used to burn VOID or other words or symbols into the card surface. Instead of, or in addition to active destruction techniques, passive destruction of the cards may be employed. Such may be achieved by for example rupturing internal chemical reservoirs 30 that release solvents, foam adhesives or inks to disfigure the card and render it useless, or destroy it physically.

Once trained and the training sequence stored in internal EEPROM memory device 32, the processor looks for the behavior pattern sequence to be repeated within a tolerance time window to allow the vault to open. Incorrect sequences are detected by the processor and result in the unit becoming dormant according to a user defined schedule. The processor eventually causes the card to be destroyed. Once the temporary sleep period is over from an invalid attempt, a correct sequence will still open the vault without any consequences.

The vault is primarily a single cast part. It has an opening for access door 14. The bottom of the case has a solid, drillable, area 12a. Thus, in one embodiment, up to two bores 22 may be formed, into which activation keys 24 may be inserted, one from each side. The bores do not intersect the vault cavity 12b in which cards are stored. The two bore embodiment is not intended to be limiting as bores may be formed to accept, for example, two keys from each side. The solid vault bottom 12a can have a horizontal bore hole 22 from either side, allowing for dual keys, sequenced operation, or different key types.

The activation keys may be in the forms of (RFID) tags, mechanical keys, magnetic keys, or optical keys. These keys replace the requirement of keyboard or keypad entry. The keys provide greatly increased mechanical security as a result by not opening the outer housing of the vault. Many variations are possible by use of the keys and their corresponding key openings, so that more sophisticated or high security versions can be implemented without extensive new mechanical design. The key entry system provides for simpler use in the basic form, for more sophisticated key sequencing based on time/motion, for use of master keys to provide repair/emergency access, and for use of dual keys for access (i.e. access by two people).

Door opening in one embodiment is by physical door opening, accomplished by the user pressing on release button 20 on the side of the case. Button 20 cooperates with an electronic release. In particular, in one embodiment as seen in FIGS. 5, 5a and 6, processor 18 controls actuation of battery powered solenoid 34. Solenoid 34 is powered by battery 36. Battery 34 translates slide 38 in direction A against the return biasing force of spring 40. Slide 38 translates so as to align aperture 42 in slide 38 with the distal end of plunger shaft 44 extending from the underside of button 20. Once so aligned, button 20 may be fully depressed in direction B against the return biasing force of spring 46 so as to rotate linkage arm 48 about shaft 50.

Although there are many ways in which arm 48 may cause unlatching of door 14, all of which intended to be within the scope of the present invention as being mechanical means which would be well understood to one skilled in the art, in the illustrated embodiment rotation of arm 48 also rotates shaft 50 so as to engage a cam surface (not shown) of shaft 50 against unlatching lever 52. Lever 52 is biased upwardly about pin 52a against the underside of door 14 and in particular against latch arm 54a of latch 54. Latch arm 54a is rotated about hinge 56 in direction C so as to remove latch 54 from engagement under lip 58 on vault 12. Once unlatched, door 14 is resiliently urged upwardly by spring 60. Because latch 54 is actuated manually, less energy is required for operation of the opening mechanism. The button may have a read (partial press) and open (full press) function, to work in conjunction with the keys, allowing both improved energy consumption, and more reliable opening with low-charge level batteries. The door may be opened by shifting the slide in a “pulse-mode” operation. Another pulse would be required to lock, and that would be prevented if battery voltage was low, helping to avoid accidentally trapping cards inside the vault with dead batteries.

As seen in FIGS. 2-4, internal construction is based on an integrated stacking assembly 60 that slides into vault 12 from the primary opening. The assembly is screwed to the vault at each side from inside the door opening. Door 14 is hinged to the top of the assembly. The cards to be protected are slidably mounted on the outside of a stack core 62, with the card's magnetic stripes facing inwardly. Orientation and alignment of cards 8 is dictated by raised lands 64 on sidewalls 66 blocking the passage the raised text 8b on cards 8 sliding therealong. Cards 8 must be slid in so as to pass the raised text to one side of lands 64 thereby orienting the magnetic stripes 8a adjacent flash bulb 28. This allows one flash bulb 28 mounted in core 62 between the cards to destroy both stripes 8a simultaneously by a flash of heat. The processor and battery may also be mounted in core 62 between the cards so that external tampering attempts must pass through a card to reach the control or battery, thereby damaging the card.

Within core 62 of the stacking assembly, batteries 36, logic processor 18 and flash bulb 28 are mounted to a central support 70. The batteries may be aligned for easy removal and replacement, but not exposed so that tampering is easily possible. As seen in FIG. 3a, the stacking assembly may have an outer wrap 72 that is conductive, but insulated, to act as the tampering sensor trigger. When a conductive path is made between the outer conductive layer and the case (by a drill bit, etc.), the cards are destroyed, for example they may be flashed by igniting the flash lamp, thereby destroying the card. This circuit bypasses the processor, and works by a simple conductive path to the destruction device, for example flash lamp. An additional wrap of mu-metal may be added for magnetic protection as a higher security feature to protect magnetic stripes 8a from external fields.

If physical battery size permits, it may be useful to have two battery systems, one for the deterrent system and processor, and one for the door release, or just the flash lamp. A mechanical door release input (a small hole) may then be added to allow opening if the door battery has expired, while retaining the deterrent.

Keying techniques may utilize I-Buttons from Dallas Semiconductor™. The key may be in a ring, or on a tag, etc. Alternatively keying may employ turn-key pellet RFID tags from Matra-Harris™. Both techniques are inexpensive and have high code security. Use of I-Buttons may somewhat compromise internal security, as the internal circuit connections are exposed via the interface. Battery re-charging may be possible, but this opens a security risk for cracking into the system security. If this is a requirement, care must be taken to avoid having any over-voltage assault on the system trip any flash lamp.

The vault may be a cast or molded case. It may be metallic, and castable or moldable. It may have a smooth surface and be sufficiently rigid to provide high dimensional stability, and may be provided with a pocket clip 68. It can be powder coated, or have inlays or overlays added adhesively as desired for cosmetic effect. An alternative embodiment may be to machine the case from a solid billet, although quite expensive to manufacture. Once cast, and prior to surface finishing, a small aperture for a key entry may be bored into the case. Any required tapping of the inside of the case for attachment screws, etc. may be done at this time.

The overall shape of the vault is preferably a solid rectangle, that is, a rectangular parallelepiped, having rounded corners. An inner cavity in the vault, which may also be rectangular, has an opening at one end of the vault. A hinged door closes the opening. Slight tapering of the rectangular case shape may be required for the mold to release, and may add to the overall aesthetic appearance. The door may be a cast metal part, or stamped, depending on the lock design.

The incandescent flash lamp bulb, if any, used to actively destroy the magnetic stripe on cards in the vault needs to be as efficient as possible, with the highest possible heat/light output from, for example, 1.5 VDC or 4 VDC depending on the battery. The bulb is exothermic, and burns at very high temperature once triggered by a small electric current, generating more heat than can be obtained from the battery. The flash bulb may be thin and flat, instead of the conventional spherical bulbs. It may have solid lead attachments at each end to avoid breakage. The bulb is normally covered with a clear lacquer. The lacquer may be marked in a pattern, for example in the form of the word VOID, so as to burn that image onto the card stripe when the bulb is flashed.

Where used, advantageously the flash bulb has a high internal resistance. The higher the internal resistance, the easier it is to trigger, especially if the battery is weak. It is also useful if it can trigger over a wide voltage range for longest battery life. The flash bulb is not a Xenon flash tube. It is a one-shot incandescent bulb that is consumed when triggered. The flash bulb may have smooth flat sides of a dimension so that the cards will not jam against the bulb surface or be damaged by abrasion.

In one embodiment, the vault case has external dimensions of approximately 1 inch-1.5 inches long, by 0.5 inch wide, by 0.3-0.4 inch thick. The battery, processor, wiring and card cradle within the stacking assembly are all mounted within the vault cavity. Cards slid into the card cradle are pressed down against the resilient return biasing force of spring 74. The upper edges 60a of the card cradle formed between assembly 60 and core 62 are beveled for smooth entry of the cards in direction D. Solderable axial wire leads 28a are provided which are strong enough to support flash bulb 28.

Battery 36 is preferably thin, with a long shelf life and an adequate pulse capability to reliably trigger both the flash bulb and the door release mechanism. It may be optimal to have a 5V-6V nominal battery for the processor, and a different battery for the flash bulb or door release. If the bulb battery and other batteries are separate, then they can be sized together for optimal performance. The bulb battery only has to fire the bulb once but it must do so reliably. The logic processor may run over a wider voltage range for example (3-6 VDC) depending on the micro controllers, and requires little current. The battery or batteries may be metal hydride or other types of batteries. A primary battery is required. The battery must fit within the space in the case cavity not taken up by the flash bulb. The batteries need to be easily replaceable, and readily identified as to polarity and location. The batteries must be leak proof, and non-explosive even at elevated temperatures such as 85° Celsius, so that no damage will occur if the vault is left in the car in sunlight or upon assault on the case using a heat source.

The door release mechanism may be the most vulnerable element of the entire vault assembly. Door 14 may seat flush into a recess within the top (i.e. a first end) of the vault, to make prying the door open difficult. An O-ring seal inside the recess inhibits water ingress and acts as a barrier to a liquid based assault on the vault. The release shaft 44 may have a simple interference device such as flange 44a to prevent full depression, and a back-up anvil 38a behind the shaft, which may be part of the vault body, to prevent an opening attempt by hammering on the door release button. Shaft 44 may be slightly depressible on a first press (to read the keys in a simple system), then pressable further when the unit is enabled by the keys so as to release the door latch. Button 20 may be positioned at the top of the vault beside the door entry surface, but this is not intended to be limiting. The primary consideration is that the shaft does not compromise vault security. The energy to release the latch comes from thumb pressure by the user so that the minimum possible electrical energy needs to be expended to enable the release. Existing electric door releases (VING™ locks, etc.) have suitable solenoid designs. A latching design is useful, as it may be pulsed briefly to release the lock, and pulsed again to close it. Closure can be prevented in this way if the battery tests low, preventing accidentally locking of the vault with depleted or weak batteries.

An audible alert may be provided by a small (SMD) piezo transducer (not shown), either self-resonant or speaker-like. It is used to give the user a momentary cyclic warning that the card has not been returned to the vault following use of the card. High energy efficiency and acoustic output are both important, as minimal power should be spared for this function. The transducer may operate in a very brief pulse mode, at wide intervals (for example, 30 seconds). It may be mounted inside the case cavity, facing out via the cavity opening which is presumed still to be open because the card has not been re-inserted.

The control functions are provided by a processor 18, for example, a Microchip™ PIC. Several models will work, and permit “programming in place” on a finished assembly, as well as “training or keying” to a random key. Non-volatile RAM is also required. Several assembly approaches may be used. The programmed processor chip may plug in, or it may be soldered in as a small SMD device, and then programmed in place. A simple test routine may be loaded to allow factory assembly and test, then the processor later programmed. One benefit of the solder-in-and-test approach is that 100% testing can be done in production, and still retain full security of the system and its code.

With regard to the key sensing system, as stated above, many key techniques are possible. The key technique will vary depending on the desired security level. If the key technique is the use of radio frequency identification, in order to read RFID tags, a small loop antenna (not shown) may be mounted at the bottom of the case to interrogate the tag with the molded key assembly. An aperture is required to the key slot to read the key. The aperture is sealed with plastic/epoxy to retain the case seal. Magnetic keys may be read via a small hall effect sensor. Optical keys may be read via a LED/photodiode reflective sensor, all via the same aperture. Aperture locations, for example, their distance from the bottom of the case, can vary, allowing considerable key variation. A stop at the end of the slot may be provided to sense full insertion via the same methods. The key may be mechanical. Sensing is then done via any satisfactory switch closure achieved via key insertion. A combination of methods may be employed. The key can have colored stripes, grooves, etc. to add additional keying clues or position sensing.

In addition to the basic key function, as stated above biometric behavior recognition may also be used. The behavior is unique to the individual user and may include time-in-place, repeated insertion, etc. which defeats casual interception and use of the key by a third party. Lock out software in the processor senses bad attempts to mimic the user's biometric behavior pattern, and sends the unit to sleep, defeating repeat trials. The processor may also detect for example three incorrect attempts within a short period, and destroy the card. The user initially follows a simple method to train the recognition processor. In one embodiment, a “learn” mode is enabled by a dummy credit card.

In the pattern behavior recognition method of access control, motions and sequences are performed by the user on the case in a way that is comfortable and natural for the user. This can be inserting and removing a mechanical key over a specific time, rotating or holding the unit in a specific attitude, inserting two keys in a specific sequence over time, or moving keys or positions over time, or combinations of these physical events. When in the training mode, the processor remembers these events, and averages at least three sequences to arrive at the “Pattern Behavior” it will use to recognize the legitimate owner of the vault. In an alternative embodiment, the recognition processor makes progressive retraining adjustments, as the user becomes more comfortable (and usually faster) using the pattern behavior access in the manner that a person's unique handwritten signature develops then stabilizes over time.

Signaling of the recognition processor to start recognition of a pattern to unlock the vault door may be done by either key insertion, or by lightly depressing the door release plunger or button. The recognition processor then monitors incoming events over time for example by monitoring the output of the motion sensor, and tests to see if the “pattern” fits the stored “behavior” associated with the owner. This electronically stored profile has tolerances in both actions and times, to allow for natural variation. If a pattern is received that matches, the door release is enabled, and pressing the button opens the door. If an invalid pattern occurs, the unit may beep or flash an LED (not shown) once, and will not respond for at least 10 seconds. If another pattern attempt begins before that time, it knows that the true owner is not attempting entry, and goes dormant for one to ten minutes.

If more invalid attempts occur, the processor arms for card destruction, and refuses to accept any further patterns. The processor algorithm then either destroys the card if another attempt begins, or goes dormant for an extended period of, for example, at least an hour. The unit avoids accidental pattern discovery by use of its dormant modes, so that repeated attempts are ignored completely. This deters thieves from attempting vault access by trial and error. Continued attempts can also destroy the card stripe or information. One example of a sequence of events leading to card destruction is set out in Table 1.

Other forms of biometrics security may also be employed in the present invention without departing from the scope thereof. As used herein and as stated above, biometrics means the precise measurement of some facet of a person's unique physiological traits, digitizing that measurement, storing it in memory, and later comparing it against the same measurement when taken again later. Thus, where in fact the physiological trait being measured is unique, it becomes exceedingly difficult, if not impossible, for a third party to duplicate the measurement. For example, fingerprint scanning, may be employed in another embodiment of the present invention by the use of a commercially available scanner, such as manufactured by Fujitsu™, mounted on the exterior of the vault. The scanner acts as the biometric sensor cooperating with the processor.

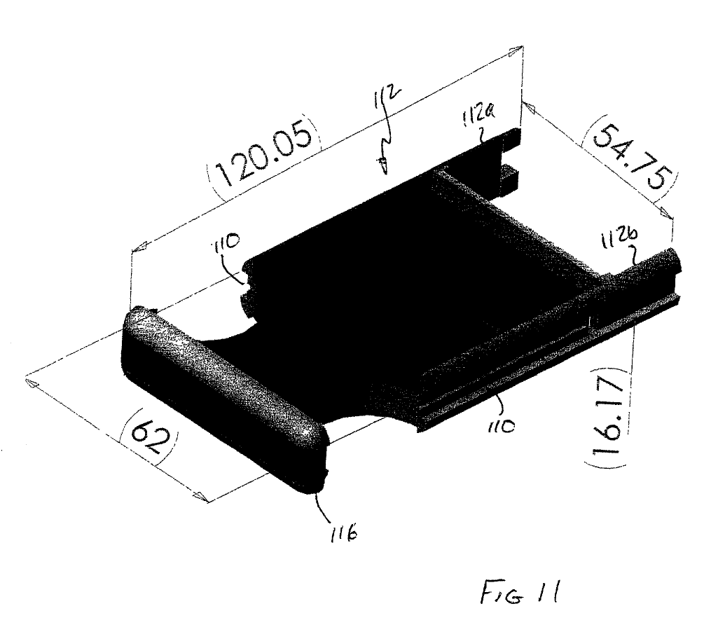

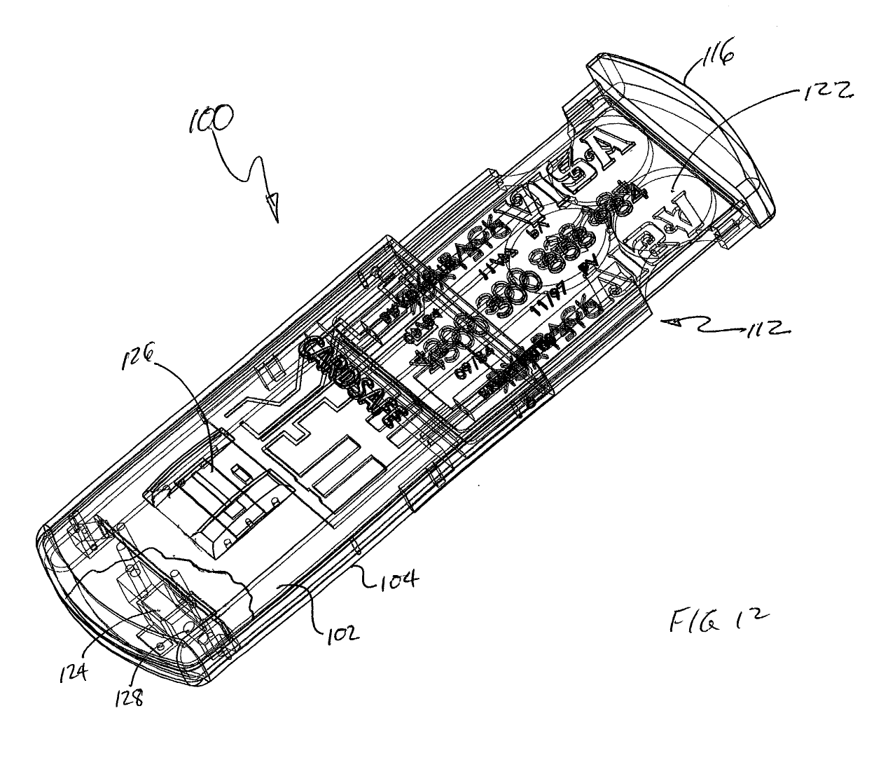

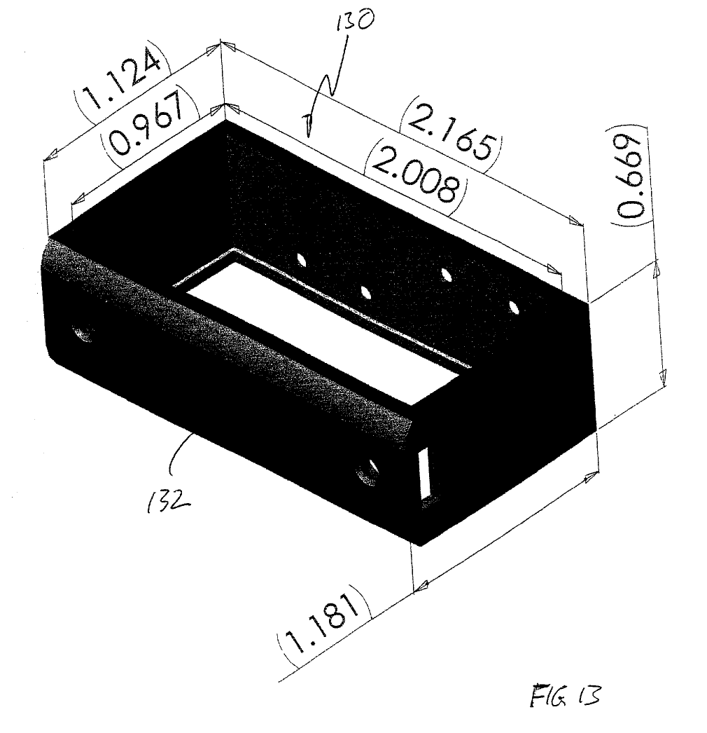

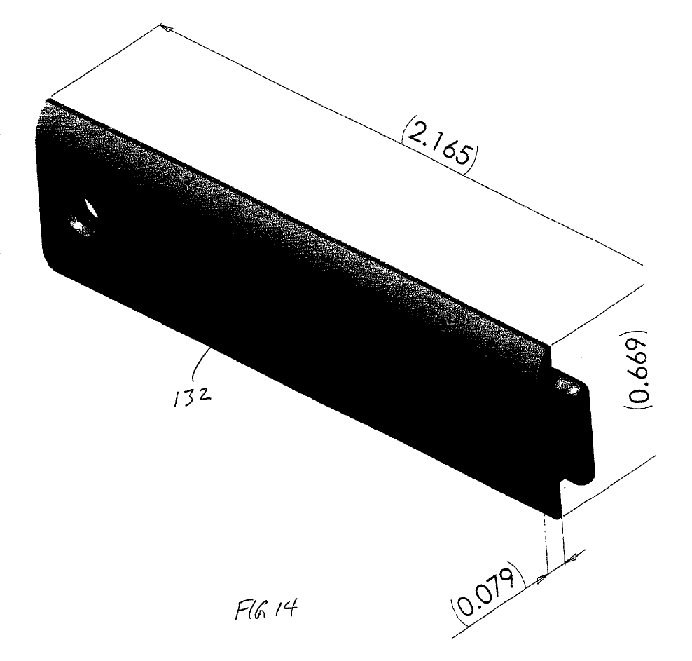

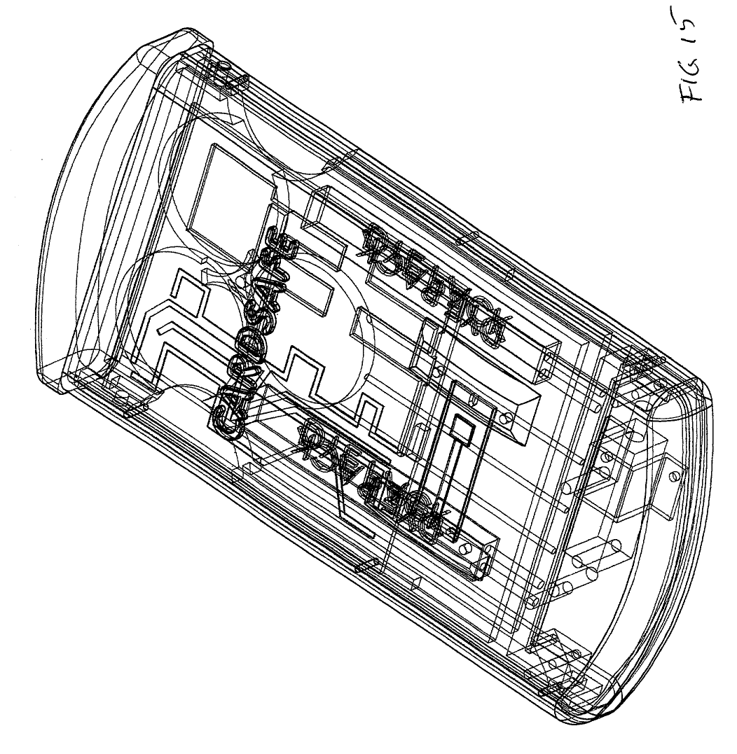

In the alternative embodiment seen in FIGS. 8-15, card security device 100 includes a vault having two mirror image half-shells 102 and 104 respectively. When assembled in opposed facing relation, the adjacent longitudinally extending edges 106 mate and are rigidly mounted to one another. An opposed facing pair of rails 108 slidably mate with corresponding channels 110 which are oppositely disposed on opposite lateral sides of a drawer 112 as better seen in FIG. 11. With drawer 112 slidably mounted within the vault formed by assembly of half-shells 102 and 104, so as to slidably mate rails 108 within channels 110, drawer 112 may be slid in direction 114 so that, in a closed position, door 116 mounted across the end of drawer 112, snugly mates against the circumferential edge 118 of opening 120 into the vault cavity defined between half-shells 102 and 104.

In the open position, drawer 112 is slid outwardly of the vault so as to expose a card 122 carried within drawer 112. As before, the batteries, processor and dye reservoirs may be carried within recesses in drawer 112, or at least the batteries, with the processor mounted within the vault so as to reside between the arms 112a and 112b of drawer 112 when the drawer is in its closed position. The processor 124 as better seen in FIGS. 12 and 15 may thus be thought of as being mounted deep within the cavity of the vault electrically connected to a biometric sensor 126, being in this embodiment a fingerprint scanner.

Upon processor 124 verifying a match between a fingerprint scanned on sensor 126 with a stored biometric template of the owner, a solenoid 128 is actuated so as to release its locking engagement with corresponding apertures in at least one of the drawer arms 112a or 112b.

In the embodiment of FIG. 8, a battery housing or chamber may be mounted in to the end of the vault opposite door 116, for example within aperture 102a in half-shell 102 and a corresponding aperture or notch formed in the corresponding end of half-shell 104. Advantageously, the battery housing 130 is entirely enclosed so that, upon removal of battery compartment door 132 access cannot be had into the vault cavity containing the processor and drawer.

If the vault is equipped with visual or audible indicators, a brief flash or tone at a specific interval warns that an attempt was made to gain access to the vault. This alerts the real owner that no access attempt is possible until the dormant period is over.

The use of multiple access levels is also possible, allowing security or supervisory personnel service access to the system, or requiring two people to be present to open the vault. This is done by supplemental key recognition, and may have pattern behavior access control incorporated as well.

In the vault embodiment equipped for use with rechargeable batteries, recessed contacts 76 may be mounted in the vault base to provide for connection to an external charger. In this embodiment, to prevent access following electrical assault, voltage in excess of the normal charging voltage is passively routed away from the internal processor, and directed into the flash destruction mechanism, so that attempts to electrically destroy the internal control system within the case merely trigger immediate card destruction.

The vault is sealed watertight when closed, so that access cannot be gained by immersing the system into fluids in an attempt to defeat the internal electronics. In addition, the insulated metal layer 72 is also built into the casing, which immediately triggers a destruction mechanism via a conductive path to the casing if an attempt is made to drill or otherwise pierce the vault walls. The case may also have spikes and/or scrape gates (not shown), which mechanically destroy and lock the card into the vault if the case is crushed or compressed. The case may also have chemical and dye defenses to mark the thief or card invisibly with UV fluorescent dye.

The door release will not re-lock if the system battery voltage is found to be low, possibly preventing later opening. This avoids user problems of trapped cards in a weak system, especially if non-rechargeable batteries are used.

TABLE 1
OPERATION

| | | |
|---|---|---|
| 1. | Wake-up recognition processor then | Wake-up is by secondary key insertion or |
| | perform recognizable behaviour pattern | other pre-trained event. |
| 2. | If behaviour pattern is recognized as | Solenoid retracted. |
| | OK, blink UNLOCKED indicator, open | |
| | mechanical release latch. | |
| 3. | If behaviour code is not recognized go | Each non-recognized attempt is counted, then |
| | idle then wait for retry | the recognition processor idled for a preset |
| | | time |
| 4. | After three incorrect retries shut off all | Warning beeper sounds. |
| | activity for further delay. beep | |
| 5. | After the delay, if another bad attempt | Warning beeper sounds |
| | is made, shut off all activity for five | |
| | minute delay. | |
| 6. | After five minute delay, if one more | Electrically trigger release of dye. |
| | bad attempt is made within a preset | |
| | time (e.g. 1 hour, 3 hours, one day), | |
| | kill card by triggering card destruction | |
| | means. | |
| 7. | Once card removed from vault, unit | Audible beep according to a “waiting for card |
| | provides audible warnings until card is | to return” program sequence. |
| | returned. | |
| 8. | Once the card is returned and | Unit will beep. Solenoid engage. |
| | detected by card sensor, and the | |
| | access door closed, the unit will self- | |
| | lock by re-engaging door latch with | |
| | access door. | |

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A card security device for cards which have coded information stored on information storage media on or within the cards comprising a releasably and lockably closable card vault, wherein said vault does not have an external key pad, said vault having a door for releasable locking enclosure of at least one of said cards within said card vault wherein, within said vault, a locking actuator for locking and unlocking said door on said vault cooperates with a recognition processor, said recognition processor cooperating with a biometric sensor, said card vault having a casing which, when closed, has no substantially structurally weakened areas which may provide for a breach access during assault on said casing,

2. The device of claim 1 wherein said card vault is releasably and lockably closable by a latch, wherein said processor which is releasable by means cooperates with said actuator for opening said latch thereby unlocking said door on said card vault so as to allow said door to be opened upon recognition and a match of a biometric sample sensed by said sensor with a biometric template stored by said processor in a memory device.

3. The device of claim 2 wherein said biometric being sensed is behaviour pattern recognition and said sensor is a motion sensor, wherein said processor monitors repeated incorrect behaviour patterns by a user, or assault of said card vault, upon which said processor triggers, by triggering means mounted within said vault, of a destruction means for rendering useless and unrecoverable said coded information on said information storage media.

4. The device of claim 1 wherein said destruction means is a fluid release means to release fluid adapted to disfigure or destroy said information storage media when said at least one card is held within said card vault and said processor triggers said triggering means.

5. The device of claim 1 wherein said sensor is a fingerprint scanner mounted on said vault and said biometric being sensed and sampled is a user's fingerprint.

6. A card security device comprising:
a case having a cavity for snugly receiving a card therein, said case having a door for sealing closed said cavity, said case having no substantially structurally weakened areas which may provide for a breach access during assault on said case,
information destroying means for destroying information storage media on said card,
user-input recognition means for receipt and recognition testing of a biometric input from a user and communication of an arming signal to said destroying means upon failure of said recognition testing so as to cause destruction of said information storage media.
